(19) United States
(12) Patent Application Publication
(10) Pub. No.: US 2008/0160456 A1
(43) Pub. Date: Jul. 3, 2008

(54) Image Sensor Fabricating Method

(76) Inventor: JU HYOUNG MOON, Arnyang-si (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/842,620

(22) Filed: Aug. 21, 2007

(30) Foreign Application Priority Data
Dec. 27, 2006 (KR) 10-2006-0134785

(51) Int. Cl. G03C 5/00

(52) U.S. Cl. 430/321

(57) ABSTRACT

An image sensor fabricating method is provided. A double exposure process is performed on a photoresist, first using a mask with line-shaped patterns in a first direction and then using a mask with line-shaped patterns in a second direction. A development process is performed to form microlenses. The mask can be two separate masks, or the same mask rotated, for example, by 90 degrees.

### CROSS-REFERENCE TO RELATED APPLICATION

The present application claims the benefit under 35 U.S.C. §119 of Korean Patent Application No. 10-2006-0134785, filed Dec. 27, 2006, which is hereby incorporated by reference in its entirety.

### BACKGROUND

An image sensor is a semiconductor device for converting optical images into electric signals.

FIG. 1 shows a typical method of forming microlenses through a related image sensor fabricating method. FIG. 1 illustrates the shape of a mask used in forming related microlenses and an example of the microlenses formed after being exposed to light through the mask.

Referring to FIG. 1, a mask 11 has a typical shape of a photo mask used in forming microlenses. Rounding of corners occurs in the photoresist 15 of wafer 13 due to the corners of square-shaped lens patterns in the mask 11. Each rounding is formed on the photoresist 15 with limited resolution, and the radius of the rounding depends on wavelength of the light used in the exposure. For example, when an I-line exposure with light having a wavelength of 365 nm is used, the radius of the rounding is about 200 nm.

Therefore, there exists a need in the art for an improved method of manufacturing an image sensor that inhibits roundings from being formed in a corner region when forming microlenses.

### BRIEF SUMMARY

Embodiments of the present invention provide an image sensor fabricating method which inhibits roundings from being formed in a corner region when forming microlenses through an exposure process.

An embodiment provides an image sensor fabricating method, which includes: forming a photoresist for forming microlenses on a color filter array; performing a first exposure process on the photoresist using a first mask in which line-shaped patterns are formed in a first direction; performing a second exposure process on the photoresist using a second mask in which line-shaped patterns are formed in a second direction; and performing a development process on the resultant object, thereby forming microlenses.

Another embodiment provides an image sensor fabricating method, which includes: forming a planarization layer on a color filter array; forming a photoresist for forming microlenses on the planarization layer; performing a first exposure process on the photoresist using a first mask in which line-shaped patterns are formed in a first direction; performing a second exposure process on the photoresist using a second mask in which line-shaped patterns are formed in a second direction; and performing a development process on the resultant object, thereby forming microlenses.

### BRIEF DESCRIPTION OF THE DRAWINGS

FIG. 1 is a view for illustrating a typical method of forming microlenses through a related image sensor fabricating method.

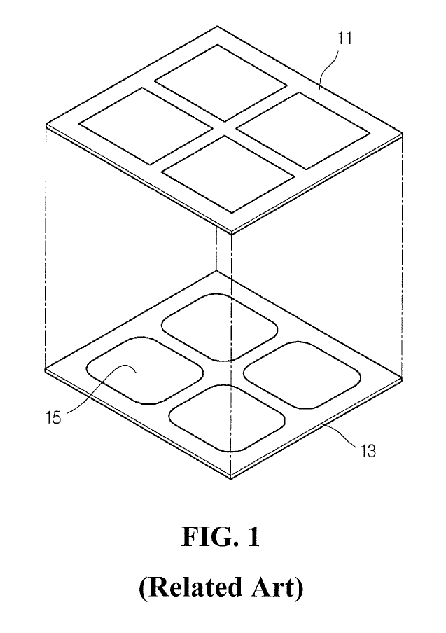

FIGS. 2 and 3 are views illustrating a method of forming microlenses through an image sensor fabricating method according to an embodiment of the present invention.

FIG. 4 is a cross-sectional view of an image sensor according to an embodiment of the present invention.

### DETAILED DESCRIPTION

When the terms “on” or “over” are used herein, when referring to layers, regions, patterns, or structures, it is understood that the layer, region, pattern or structure can be directly on another layer or structure, or intervening layers, regions, patterns, or structures may also be present. When the terms “under” or “below” are used herein, when referring to layers, regions, patterns, or structures, it is understood that the layer, region, pattern or structure can be directly under the other layer or structure, or intervening layers, regions, patterns, or structures may also be present.

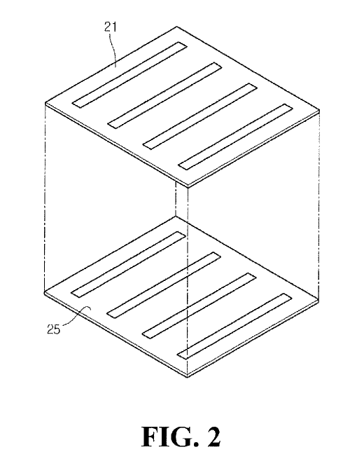

FIGS. 2 and 3 are views illustrating a method of forming a microlens through an image sensor fabricating method according to an embodiment of the present invention.

According to embodiments of the present invention, a microlens is formed using a double exposure technique. In an embodiment, double exposure is performed using parallel and vertical patterns each having an isolated space. Accordingly, rounding due to the exposure associated with typical processes can be inhibited from being formed at a region in which the horizontal and vertical patterns intersect each other. When a corner rounding is produced, its effect can be minimized. In many embodiments, the X/Y size of a microlens can be easily controlled.

Referring to FIGS. 2 and 3, a photoresist 25 for forming microlenses can be formed on a color filter array. In an embodiment, before forming the color filter array, the image sensor fabricating method includes a step of forming a light-receiving portion on a semiconductor substrate. The light-receiving portion may be formed as, for example, a photodiode.

Next, a first exposure process is performed on the photoresist 25 using a first mask 21 in which line-shaped patterns are formed in a first direction.

Subsequently, a second exposure process is performed on the photoresist 25 using a second mask 31 in which line-shaped patterns are formed in a second direction. In an embodiment, the first and second directions are perpendicular to each other.

In one embodiment, the first mask 21 and the second masks 31 are the same mask. In this case, the same mask may be rotated by 90 degrees after the first exposure process to be used in the second exposure process. In an alternative embodiment, the first mask 21 and the second mask 31 are different masks.

The width of the pattern formed by the first mask 21 may be identical to that of the pattern formed by the second mask 31. Alternatively, the width of the pattern formed by the first mask 21 may be different than that of the pattern formed by the second mask 31. Having such control over the widths of the patterns respectively formed by the first mask 21 and the second mask 31 allows the X/Y size of a microlens to be easily controlled.

A development process is performed after the double exposure process, thereby forming a microlens. The microlenses formed through the first and second exposure processes can be implemented as gapless microlenses.

After forming the microlenses, the image sensor fabricating method according to an embodiment may further include a step of forming a low temperature oxide (LTO) layer on the microlenses.

The microlenses formed according to the present invention can be formed directly on the upper surface of a color filter array. In an alternative embodiment, a planarization layer can be formed on the color filter array, and microlenses can be formed on the planarization layer.

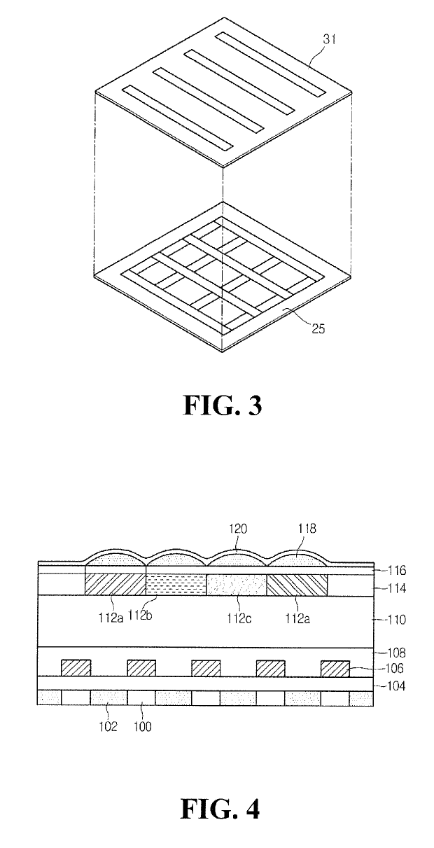

Referring to FIG. 4, the image sensor according to one embodiment includes at least one light-receiving portion 102 formed on a semiconductor substrate, as well as field insulating layers 100 and interlayer dielectric layers 104 and 108 for performing interlayer insulation with respect to top surfaces of the field insulating layers 100 and the light receiving portions 102. The image sensor may also include a light shield layer 106 formed in the interlayer dielectric layer 108 to prevent light from going into regions besides the light-receiving portions 102.

A passivation layer 110 can be formed on the interlayer dielectric layer 108. Red, green and blue color filters 112a, 112b, and 112c, respectively, can be arrayed on the passivation layer 110 and may be next adjacent to an interlayer dielectric layer 114. A planarization layer 116 can be formed on the color filters 112a, 112b, and 112c. Microlenses 118, each having the shape of a convex lens, can be formed respectively at positions corresponding to the color filters 112a, 112b, and 112c. An LTO layer 120 can be formed on the microlenses 118. In an embodiment, the microlenses 118 are gapless.

According to an embodiment, incoming light is condensed through the microlenses 118, and red, green and, blue light is filtered through the corresponding red, green, and blue color filters (112a, 112b, and 112c, respectively). In this embodiment, the filtered light is incident to the light-receiving portions 102, such as photodiodes, positioned below the color filters 112a, 112b, and 112c through the passivation layer 110 and the interlayer dielectric layers 104 and 108. The light shield layer 106 can inhibit incident light from passing through another path.

When forming microlenses by performing an exposure process according to the present invention, roundings can be prevented from being formed in a corner region of a photoresist, and gapless microlenses can be formed.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for fabricating an image sensor, comprising:
forming a photoresist on a substrate;
performing a first exposure process on the photoresist using a mask comprising line-shaped patterns positioned in a first direction;
performing a second exposure process on the photoresist using a mask comprising line-shaped patterns positioned in a second direction; and
performing a development process with respect to the exposed photoresist to form at least one microlens.

2. The method according to claim 1, wherein the second direction is approximately perpendicular to the first direction.

3. The method according to claim 1, wherein the mask comprising line-shaped patterns positioned in a first direction is rotated approximately 90 degrees to be used as the mask comprising line-shaped patterns positioned in a second direction.

4. The method according to claim 1, wherein the width of each line-shaped pattern in the first direction is approximately the same as the width of each line-shaped pattern in the second direction.

5. The method according to claim 1, wherein the width of each line-shaped pattern in the first direction is different from the width of each line-shaped pattern in the second direction.

6. The method according to claim 1, further comprising forming at least one light-receiving portion on a semiconductor substrate.

7. The method according to claim 6, wherein the at least one light-receiving portion comprises a photodiode.

8. The method according to claim 1, further comprising forming a low temperature oxide (LTO) layer on the at least one microlens.

9. The method according to claim 1, wherein no gap exists between the at least one microlens and any adjacent microlenses.

10. The method according to claim 1, further comprising forming a color filter array on the substrate before forming the photoresist on the substrate.

11. The method according to claim 10, further comprising forming a planarization layer on the color filter array before forming the photoresist on the substrate.
